(19) United States
(12) Patent Application Publication
(10) Pub. No.: US 2004/0101618 A1
(43) Pub. Date: May 27, 2004

(54) Method for producing a light-emitting device and corresponding light-emitting device

(76) Inventors: Clemens Ottermann, Hattersheim (DE); Frank Bohm, Westhofen (DE); Frank Voges, Maxdorf (DE)

Correspondence Address: Charles N J Ruggiero, Ohlandt Greeley Ruggiero & Perle, 10th Floor, One Landmark Square, Stamford, CT, 06901-2682, US

(21) Appl. No.: 10/467,226

(22) PCT Filed: Feb. 6, 2002
(86) PCT No.: PCT/EP02/01227

(30) Foreign Application Priority Data
Feb. 6, 2001 (DE) 101 05 611.7

(51) Int. Cl. H05B 33/10; H05B 33/12

(52) U.S. Cl. 427/66; 428/690; 428/917; 313/504; 313/506

(57) ABSTRACT

The invention provides an improved process for producing a light-emitting device. To this end, the process comprises the steps of:

(i) precoating a substrate with a first, preferably transparent, conductive layer or using a preferably transparent, conductive substrate as a first layer, the first layer preferably having a high work function and particularly preferably being able to act as a resistive hole-injection electrode,

(ii) applying a thin transparent layer of a preferably soluble monomer or polymer or of a mixture of at least one monomer and/or at least one polymer, preferably from a solution, direct to the first layer, and

(iii) producing a preferably negative electron-injecting contact, particularly preferably from calcium or a metal with a relatively low work function, directly on the polymer film,

in which process at least one layer is applied by dip coating.

The invention relates to a process for producing a light-emitting device which is able to emit in particular visible light, and to a light-emitting device.

Organic light-emitting devices (diodes, OLEDs) are the subject of intensive development work, since they have particular advantages over other technologies which are used. For example, OLEDs have extremely promising properties for flat screens, since they allow a significantly larger viewing angle compared, for example, to LCD displays and also, as self-illuminating displays, allow a reduced current consumption compared to the backlit LCD displays. Moreover, OLEDs can be produced as thin, flexible films which are particularly suitable for special applications in lighting and display technology.

However, there are still difficulties with producing OLEDs, and consequently the scrap rate and the durability of these devices have to date still prevented such devices from making an increased impact on the market. In particular, inexpensive production processes, such as vapor deposition techniques, spin coating or printing techniques, for the uniform coating of large areas with OLED structures are only available with considerable restrictions.

Processes of this type are used, for example, to produce organic light-emitting diodes. However, a huge drawback of these processes is that the layers applied, in particular the electroluminescent polymer layers, do not have the desired layer homogeneity.

This is highly undesirable, since the materials which are to be applied entail high costs in the event of excessively high scrap rates or process-induced material losses, and also the size of areas which can be produced are limited.

It is true that OLEDs whose electroluminescent layers are composed of molecules of relatively low molar masses can be produced by physical vapor deposition (PVD) of these layers in vacuo. Organic multilayer systems can generally be deposited using this process without any fundamental technological barriers, since, given a suitable selection of production parameters, the layers which have already been deposited are not destroyed again by the new layers to be applied. Reproducible production of sufficiently uniform layers is technically highly complex, and the vapor deposition coating of large areas in vacuo entails relatively high production costs.

The deposition of dissolved organic substances in particular with high molar masses has proven an interesting alternative to the PVD processes. Polymer layers of this type produced using suitably selected deposition processes from the liquid phase are distinguished by a greater process stability, and the production process is much less expensive.

Spin coating is generally by far the most common method used to apply the polymer layers to small-area substrates, since it can be used to produce homogenous thin films without significant technical outlay. However, the material losses are significant, since in the case of spin coating the majority of the material applied is thrown back off the surface which is to be coated. Since in particular the electroluminescent polymers are generally relatively expensive, the low material efficiency of spin coating leads to increased production costs. A further significant drawback of spin coating is that the technical demands imposed for coating large areas using this process quickly become complex and expensive, and that it is generally impossible for areas of any desired size to be coated with sufficient uniformity.

However, there is also the further problem that high-efficiency OLEDs generally require more than one organic layer in the layer structure. These layers have to be applied in succession without the individual layers mixing with one another in uncontrolled fashion or layers which have already been applied being dissolved again.

Therefore, where there are more than two organic layers, the difficulty consists in finding orthogonal solvents for the third and further layers.

The invention is therefore based on the object of eliminating or at least reducing the above difficulties in the production of organic layers, in particular for the production of OLEDs.

This object is achieved, in a surprisingly simple way, by the method as claimed in claim 1 or claim 25 and by the light-emitting device as claimed in claim 37.

The process advantageously comprises the steps of

(i) precoating a substrate with a first, preferably transparent, conductive layer or using a preferably transparent, conductive substrate as a first layer,

the first layer preferably having a high work function and particularly preferably being able to act as a resistive hole-injection electrode,

(ii) applying a thin transparent layer of a preferably soluble monomer or polymer or of a mixture of at least one monomer and/or at least one polymer, preferably from a solution, direct to the first layer, and

(iii) producing a preferably negative electron-injecting contact, particularly preferably from calcium or a metal with a relatively low work function, directly on the polymer film,

in which process at least one layer is applied by dip coating.

In an advantageous embodiment, the contact can advantageously be used as a rectifying contact in a light-emitting diode structure.

If after or during the dip coating a polymerization or partial polymerization of the monomer or polymer or of the mixture of at least one monomer and/or at least one polymer is carried out, the dip-coating operation can not only be carried out extremely quickly, meaning that a fixedly applied layer is very soon present, but also it is possible to use the degree of polymerization to influence the viscosity during the dip-coating and to apply defined layers with a high level of accuracy and a high level of uniformity.

It is also possible for in particular a polymerization or crosslinking of a polymer layer to be carried out during or after the dip-coating. This greatly reduces the solubility of layers which have been applied in the solvents of subsequent coatings, so that when producing a layer system there are no restrictions in the choice of suitable solvents and/or it is possible to dispense with the use of orthogonal solvents.

Preferably, the polymerization is effected by UV or light irradiation, ion or electron irradiation, the action of heat, a chemical action or by a combination of UV irradiation, light irradiation, ion or electron irradiation, the action of heat and/or a chemical action.

In a particularly preferred embodiment, the substrate is a glass substrate, which is eminently suitable for shielding the layer which has been applied from environmental influences.

For many further applications, it is desirable for the glass substrate to have a thickness of less than 150 μm, since this makes it possible to produce extremely thin illumination devices. Moreover, if ultrathin glass of this type is used, it is possible to achieve a high degree of flexibility combined, at the same time, with a sufficient diffusion barrier action.

The dip-coating may also advantageously take place in a controlled atmosphere, in particular an inert gas atmosphere, with in particular the solvent concentration being controlled in the atmosphere in order to control the evaporation and drying characteristics of the layer.

If the dip-coating is carried out in a protective gas atmosphere, it is possible to prevent influences from atmospheric humidity, solvents and additional reaction partners.

In another variant of the method, the dip-coating is carried out in an environment which is enriched with a chemical, polymerization-generating species, in order in this way to exert a defined influence on the polymerization.

In a preferred embodiment, a plurality of layers comprising a monomer or a polymer or a mixture of at least one monomer and/or at least one polymer are applied in succession, the next layer advantageously only being applied after the polymerization or partial polymerization of the preceding layer.

By applying a plurality of layers it is possible, for example, to match potentials between the polymer layer and the contact used as a resistive hole-injection electrode.

To increase the durability of the layer structure and to improve its optical and electrical properties, the process may advantageously also comprise the step of crosslinking at least one of the layers. Moreover, the process may also comprise the crosslinking of at least two of the layers at their common interface. In this way, the individual layers are directly joined to one another at their interface, which is advantageous for the conductivity and homogeneity of the interface between the layers.

In this context, it is useful and advantageous if the monomer or polymer or mixture of at least one monomer and a polymer of a preceding layer is in each case insoluble or only slightly soluble in the following layer and/or in a solvent of a solution of a subsequent dip-coating.

Advantageously, at least one of the layers comprises an electroluminescent material.

Furthermore, the generally transparent, conductive first layer advantageously comprises an electronegative metal, such as for example gold. The transparent, conductive first layer in this case generally acts as an anode of the light-emitting device.

Other materials may also be of particular benefit to the first, conductive layer. By way of example, it is also possible to use conductive, transparent plastics or grids of metallic tracks. In particular, a conductive layer of this type makes it possible for individual regions of the substrate to be selectively supplied with voltage.

Alternatively, the transparent, conductive first layer may also include a conductive metal oxide, such as for example indium/tin oxide.

In the light-emitting device, the electron-injecting contact generally acts as a cathode. For this purpose, the electron-injecting contact may advantageously comprise calcium. Calcium has a low work function of approximately 2 eV, so that the energy gap of the conduction electrons with respect to the vacuum level can be well matched to the LUMO (Lowest Unoccupied Molecular Orbital) level of many organic electroluminescent materials and can therefore inject electrons into the LUMO level. Correspondingly, however, it is also possible to use other contact materials, depending on the material of the electroluminescent layer.

In accordance with the invention, electroluminescent polymers or polymers for further OLED-relevant organic layers or correspondingly polymerizing monomers which are crosslinkable or polymerizable can also be used. Substances of this type are described, for example, in U.S. Pat. No. 6,107,452, which is hereby incorporated by reference in its entirety in the present application. Although this is known to the person skilled in the art, reference is also made to the structure of the organic light-emitting diodes described in this document, and this description is presupposed to form part of the present application.

Furthermore, it is also possible to use the polymers described in documents EP 0 573 549, EP 800563 A1, EP 800563 B1 and EP 1006169 A1, it being possible to use the solvent contents to set viscosities for the dip-coating, so that desired layer thicknesses can be set by means of the drawing rate, the degree of saturation of the atmosphere with solvent, the temperature which prevails and an existing partial polymerization.

By dip-coating, it is possible for organic substances to be deposited on a substrate in the form of thin films from a liquid phase, the films or layers being distinguished by a high level of uniformity. In this process, it is particularly advantageous that even large-area substrates can be coated without problems.

For this purpose, the materials described above are generally introduced into a vessel which is open at the top and into which the substrate to be coated is dipped and then drawn out at a defined rate, a film comprising the materials described above remaining behind on the substrate in a defined thickness and then being crosslinked or polymerized.

Since highly efficient organic light-emitting devices generally require more than one organic layer, the interface between the organic layers is also of crucial importance to the electrical and optical properties of a light-emitting device. By crosslinking the organic layers at their common interface, the process according to the invention creates intimate contact which is homogenous over the entire area of the light-emitting device.

A variant of the invention provides a process for producing a light-emitting device which is able to emit in particular visible light, the process comprising the step of applying at least a first and a second organic layer to a substrate, and at least one of the organic layers is applied by means of dip-coating and at least one layer is polymerized and/or crosslinked.

In this case, the first and second layers are advantageously applied to one another in such a way that the first layer crosslinks with the second layer.

The dip-coating may in this case take place in such a way that during or after the dip-coating operation a monomer or polymer or a mixture of at least one monomer and a polymer is polymerized. This makes it possible, for example, to crosslink the layers with one another during the polymerization operation. Moreover, this process offers the option of depositing insoluble polymers of soluble monomers or polymers on the substrate. The polymerization may in this case advantageously be effected by UV irradiation, ion or electron irradiation, the action of heat, a chemical action or by a combination of UV irradiation, ion or electron irradiation, the action of heat and/or a chemical action.

In addition to the electroluminescent layer, it is also possible, for example, for a layer with a preferably pronounced hole conductivity to be deposited as an organic layer, this layer advantageously including PEDOT (polyethylene-dioxythiophene) and/or PEDOT-PSS (polyethylene-dioxythiophene-polystyrenesulfonic acid) and/or PANI (polyaniline).

Layers which include these materials are particularly suitable for balancing out electron and hole currents through the electroluminescent layer and thereby increasing the efficiency of the organic light-emitting device.

Inter alia, organic substances which include paraphenylvinylene derivatives (PPV derivatives) and/or polyfluorenes are suitable for electroluminescent layers.

It is advantageously also possible for a dye to be embedded in at least one of the organic layers. In this way it is possible, for example, to produce electroluminescent layers with special dyes as active substances and/or as electroluminescent materials which cannot themselves be polymerized. In this context, it is particularly advantageous if the dyes are embedded in a polymer matrix.

Moreover, pigments may be incorporated in at least one of the organic layers, in order to influence the color sensation or the light spectrum emitted.

By crosslinking at least one organic layer, it is possible to produce particularly stable layers which are especially resistant to solvents during the deposition of further layers.

It is advantageously possible for a contact layer to be applied to the substrate prior to the application of the organic layers. Depending on the material, the layer can be used either as an anode or as a cathode for the organic light-emitting device. Accordingly, to make electrical contact with the device, it is possible for a contact layer to be applied to the organic layers which have been applied. The material is in this case advantageously selected in such a way that this contact layer acts as a cathode if a material which acts as an anode has been used as contact layer on the substrate, and vice versa. Suitable layer substances for this purpose, for the two contact layers, are in each case the materials described above, such as for example gold as anode or electronegative material or calcium as cathode or electron-injecting material.

The invention is not restricted to the materials described above, since the person skilled in the art can easily find further crosslinkable or polymerizable electroluminescent materials whose viscosity can be influenced.

The invention is described in more detail below on the basis of preferred embodiments and with reference to the appended drawings, in which:

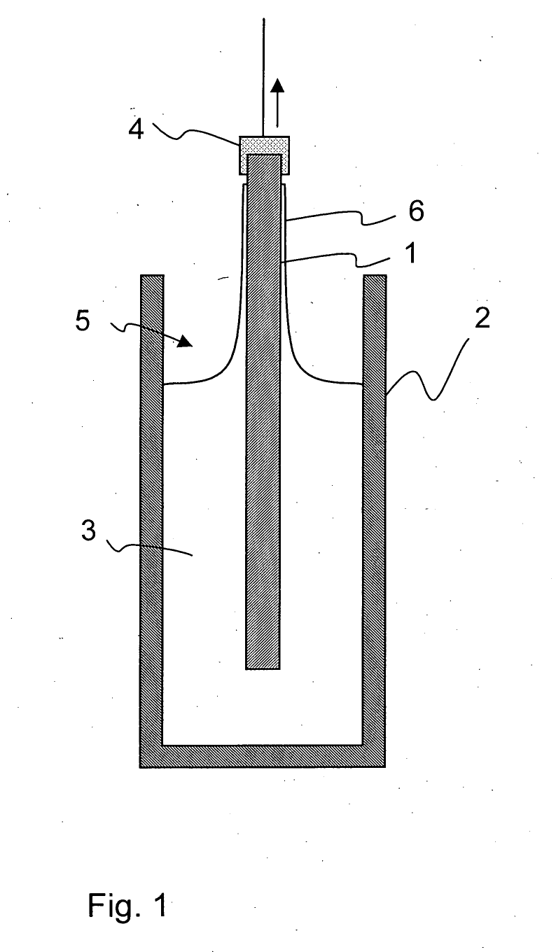

FIG. 1 diagrammatically depicts a dip-coating apparatus,

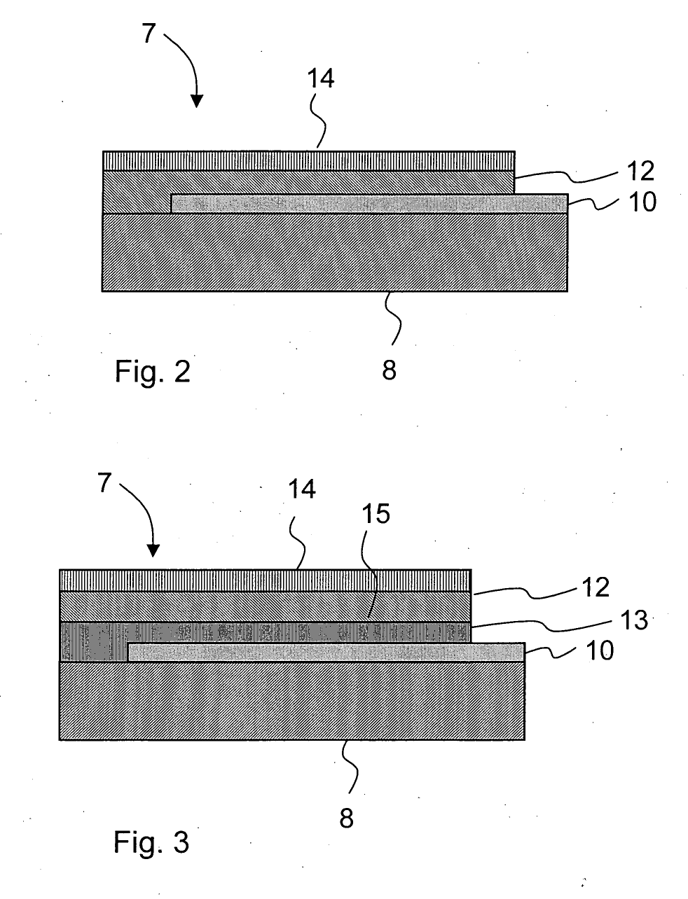

FIG. 2 shows a diagrammatic cross section through an embodiment of the light-emitting device,

FIG. 3 shows a diagrammatic cross section through a further embodiment of the light-emitting device, and

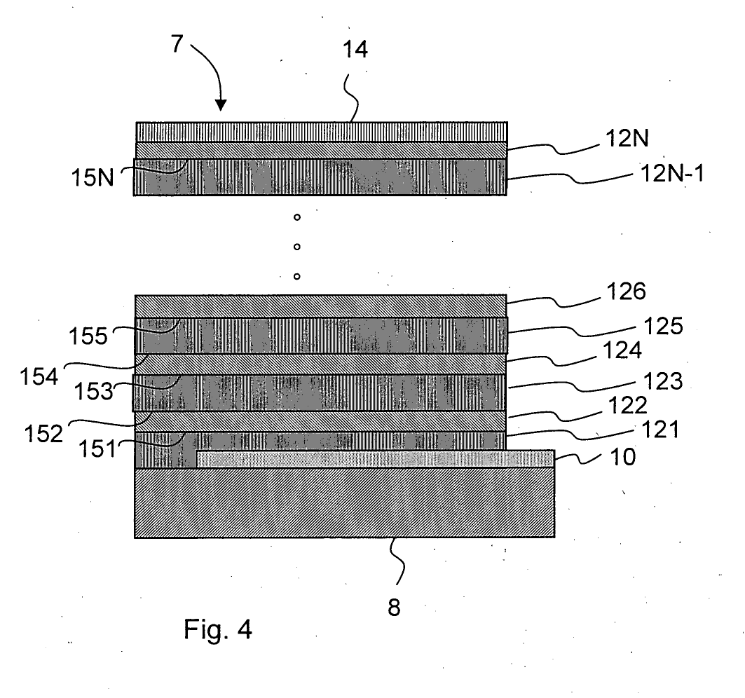

FIG. 4 shows a diagrammatic cross section through yet another embodiment of the light-emitting device.

FIG. 1 diagrammatically depicts an embodiment of an apparatus used for the dip-coating of substrates. This apparatus is particularly suitable for carrying out process according to the invention for the production of organic light-emitting devices. The apparatus comprises a vessel or a tank 2 and a substrate holder 4, on which a substrate 1 attached to it can be moved in or oppositely to the direction of the arrow. For the dip-coating of the substrate, the tank 2 is filled with a liquid 3. The liquid consists of a solvent in which suitable polymers and/or monomers are dissolved. The substrate which is dipped into the solvent 3 at the start of the dip-coating is then slowly drawn out of the tank, with a film of liquid 6 remaining attached to the surface of the substrate 1 on account of the adhesion forces which prevail between substrate and solvent.

Evaporation of the solvent then leaves a polymer layer on the substrate. In addition, during or after the dip-coating it is possible to polymerize or crosslink the monomer or polymer or the mixture of at least one monomer and/or at least one polymer. The polymerization may, for example, be effected by UV or light irradiation, ion or electron irradiation, the action of heat, a chemical action and/or by a combination of UV irradiation, ion or electron irradiation, the action of heat and/or a chemical action.

The crosslinking and/or polymerization may, for example, take place in an area 5 above the liquid 3 by means of one of the actions referred to above. As an alternative or in addition to the polymerization, it is also possible to crosslink the deposited polymers in order to make the polymer layer highly stable in particular with respect to solvents in subsequent further coating operations, in particular in the dip-coating process.

FIG. 2 shows a diagrammatic cross section through an embodiment of the light-emitting device. The light-emitting device 7 has a glass substrate 8, to which a transparent, conductive layer 10 has been applied, via which, on the one hand, it is possible to make contact with the device and through which, on the other hand, the light emitted by the device 7 can pass, so that it is visible through the glass substrate. The transparent, conductive layer may, for example, be made from indium/tin oxide. In this embodiment, an electroluminescent layer 12 has been applied to the substrate 7 coated with the conductive, transparent layer 10, the application being effected by means of dip-coating. The layer 12 can in this case be polymerized and/or crosslinked following the dip-coating or during the coating operation. As a counterelectrode to layer 10, a further conductive layer 14 is applied to the electroluminescent layer 12, so that an electric voltage can be applied between the layers 10 and 14, by which electric charge is transported through the electroluminescent layer 12, triggering the luminescence.

FIG. 3 shows a diagrammatic cross section through a further embodiment of the light-emitting device. This embodiment differs from the embodiment shown in FIG. 2 in that it has two organic layers 12 and 13, the substrate 8 first of all being coated with a conductive contact layer 10, as in the above example, and then a transparent, conductive polymer layer 12 being applied to the contact layer 10. For its part, the electroluminescent layer 12 has been applied to the conductive layer 13. One or both of the polymer layers 12 and 13 may in this case be applied by means of dip-coating. At least one of the layers is polymerized or crosslinked for this purpose. In this case, it is preferable for the layers applied first to be crosslinked or polymerized, so that they can no longer be adversely affected by subsequent process steps. In particular, damage caused by swelling, partial or complete dissolution or detachment is avoided.

In particular, the coating with the electroluminescent layer 12 can be carried out in such a way that crosslinking occurs at the interface 15 between molecules of the layers 12 and 13, so that intimate contact is produced between the two layers, having a beneficial influence on the mechanical stability and homogeneity of the electrical resistance along the surface of the device. In this example, the layer 13 serves as a hole transport layer, by means of which, inter alia, it is possible to match the potential of the substrate-side electric contact to the electroluminescent layer 12.

FIG. 4 shows a diagrammatic cross section through yet another embodiment of the light-emitting device. This embodiment differs from the embodiment shown in FIG. 3 in that it has a layer sequence comprising a multiplicity of organic layers 121, 122, 123, . . . , 12N. At least one of the layers 121, 122, 123, . . . , 12N may in this case advantageously be crosslinked and/or polymerized in order, for example, to improve the stability of the layer.

As in the embodiment illustrated with reference to FIG. 3, it is also possible for individual coating operations to be carried out in such a way that crosslinking occurs at at least one of the interfaces 151, 152, . . . , 15N between molecules of the layers which in each case adjoin one another. According to the particular function, some of the layers 121, 122, 123, . . . , 12N may, for example, serve as electroluminescent layers, pigment-doped layers, layers which act as resistive hole-injection electrodes or electron-injecting layers.

1. A process for producing a light-emitting device (7) which is able to emit in particular visible light, the process comprising the following steps:
(i) precoating a substrate (8) with a first, preferably transparent, conductive layer or using a preferably transparent, conductive substrate (8) as a first layer,
the first layer (10) preferably having a high work function and particularly preferably being able to act as a resistive hole-injection electrode,
(ii) applying a thin transparent layer of a preferably soluble monomer or polymer or of a mixture of at least one monomer and/or at least one polymer, preferably from a solution, direct to the first layer, and
(iii) producing a preferably negative electron-injecting contact (14), particularly preferably from calcium or a metal with a relatively low work function, directly on the polymer film (12, 121, 122, 123, . . . 12N),
in which process at least one layer is applied by dip coating.

2. The process as claimed in claim 1, in which the contact can be used as a rectifying contact in a light-emitting diode structure.

3. The process as claimed in claim 1 or 2, in which after or during the dip coating a polymerization or partial polymerization of the monomer or polymer or of the mixture of at least one monomer and/or at least one polymer is carried out.

4. The process as claimed in claim 1, 2 or 3, in which the polymerization is effected by UV or light irradiation, ion or electron irradiation, the action of heat, a chemical action or by a combination of UV irradiation, light irradiation, ion or electron irradiation, the action of heat and/or a chemical action.

5. The process as claimed in one of the preceding claims, in which the substrate (8) is a glass substrate.

6. The process as claimed in claim 5, in which the glass substrate (8) has a thickness of less than 150 μm.

7. The process as claimed in claim 5 or 6, in which the glass substrate has a thickness of less than 75 μm.

8. The process as claimed in one of the preceding claims, in which the dip-coating is carried out in a controlled atmosphere, in particular an inert gas atmosphere.

9. The process as claimed in one of the preceding claims, in which the dip-coating is carried out in a protective gas atmosphere.

10. The process as claimed in one of claims 1 to 9, in which the dip-coating is carried out in an environment which is enriched with a chemical, polymerization-generating species.

11. The process as claimed in one of the preceding claims, in which a plurality of layers comprising a monomer or a polymer or a mixture of at least one monomer and/or at least one polymer are applied in succession.

12. The process as claimed in one of claims 1 to 11, also comprising the step of crosslinking at least one of the layers.

13. The process as claimed in one of claims 1 to 12, also comprising the step of crosslinking at least two layers at their common interface.

14. The process as claimed in claim 11, 12 or 13, in which the next layer is in each case applied after the polymerization or partial polymerization of the preceding layers.

15. The process as claimed in one of claims 11 to 14, in which the monomer or polymer or mixture of at least one monomer and/or at least one polymer of a preceding layer is in each case insoluble or only slightly soluble in the following layer and/or in a solvent of a solution of a subsequent dip-coating.

16. The process as claimed in one of the preceding claims, in which at least one of the layers comprises an electroluminescent material.

17. The process as claimed in one of the preceding claims, in which the conductive first layer is an electronegative metal.

18. The process as claimed in claim 17, in which the electronegative metal comprises gold.

19. The process as claimed in one of the preceding claims, in which the transparent, conductive first layer includes a conductive plastic.

20. The process as claimed in one of the preceding claims, in which the transparent, conductive first layer includes a grid of metallic tracks.

21. The process as claimed in one of claims 1 to 20, in which the transparent, conductive first layer comprises a conductive metal oxide.

22. The process as claimed in claim 21, in which the conductive metal oxide comprises indium/tin oxide.

23. The process as claimed in one of the preceding claims, in which the preferably electron-injecting contact is calcium.

24. The process as claimed in one of the preceding claims, in which the light-emitting device (7) is an organic light-emitting diode.

25. A process for producing a light-emitting device which is able to emit in particular visible light, the process comprising the step of applying at least a first and a second organic layer to a substrate (7), characterized in that the application step comprises the steps of
(i) applying at least one of the organic layers by means of dip-coating, and of
(ii) polymerizing and/or crosslinking at least one layer.

26. The process as claimed in claim 25, also comprising the step of crosslinking at least two successive layers to one another.

27. The process as claimed in claim 24 or 25, in which during or after the dip-coating a polymerization of a monomer or a polymer or a mixture of at least one monomer and/or at least one polymer is carried out.

27. The process as claimed in claim 26, in which the polymerization is effected by UV irradiation, light irradiation, ion or electron irradiation, the action of heat, a chemical action or by a combination of UV irradiation, ion or electron irradiation, the action of heat and/or a chemical action.

28. The process as claimed in one of claims 25 to 27, in which at least one of the organic layers comprises PANI, PEDOT and/or PEDOT-PSS.

29. The process as claimed in one of claims 25 to 28, in which at least one of the organic layers comprises PPV derivatives and/or polyfluorenes.

30. The process as claimed in one of claims 25 to 29, characterized by the step of embedding a dye in at least one of the organic layers.

31. The process as claimed in claim 30, in which the step of embedding a dye comprises the step of embedding the dye in a polymer matrix.

32. The process as claimed in one of claims 25 to 31, characterized by the step of crosslinking at least one organic layer.

33. The process as claimed in one of claims 25 to 32, also comprising the step of applying a conductive contact layer to the substrate (7).

34. The process as claimed in one of claims 25 to 33, also comprising the step of applying a conductive contact layer (10, 14) to the at least two organic layers.

35. The process as claimed in one of claims 25 to 34, in which at least one of the organic layers (12, 121, 122, 123, . . . 12N) includes pigments.

36. A light-emitting device, characterized by being produced as claimed in one of the preceding claims 1 to 35.

37. A light-emitting device, preferably produced as described in one of the preceding claims 1 to 35, comprising
a substrate (7) having a first, preferably transparent, conductive layer (12, 13, 121) or a preferably transparent, conductive substrate (7) which acts as a first layer,
in which the first layer (12, 13, 121) preferably has a high work function and is particularly preferably able to act as a resistive hole-injection electrode,
a thin transparent layer of a, preferably soluble, monomer or polymer or of a mixture of at least one monomer and a polymer, a preferably negative electron-injecting contact (14), preferably made from calcium or a metal with a relatively low work function, directly on the polymer film,
in which at least one layer was applied by dip-coating and the monomer or polymer or the mixture of at least one monomer and a polymer was polymerized further.

38. The device as claimed in claim 37, in which the contact (14) is used as a rectifying contact in a light-emitting diode structure.

39. The device as claimed in claim 37 or 38, in which, during or after the dip-coating, the monomer or polymer or the mixture of at least one monomer and/or at least one polymer was polymerized.

40. The device as claimed in claim 37, 38 or 39, in which the polymerization was effected by UV irradiation, light irradiation, ion or electron irradiation, the action of heat, a chemical action or by a combination of UV irradiation, light irradiation, ion or electron irradiation, the action of heat and/or a chemical action.

41. The device as claimed in one of the preceding claims 37 to 40, in which the substrate (7) is a glass substrate.

42. The device as claimed in claim 41, in which the glass substrate has a thickness of less than 150 μm.

43. The device as claimed in claim 41 or 42, in which the glass substrate has a thickness of less than 75 μm.

44. The device as claimed in one of the preceding claims 37 to 43, in which the dip-coating is carried out in a protective gas atmosphere, in particular an inert gas atmosphere.

45. The device as claimed in one of claims 37 to 44, in which the dip-coating is carried out in an environment which is enriched with a chemical, polymerization-generating species.

46. The device as claimed in one of the preceding claims 37 to 45, in which a plurality of layers (12, 13, 121, 121, . . . 12N) comprising a monomer or a polymer or a mixture of at least one monomer and/or at least one polymer were applied in succession and polymerized.

47. The device as claimed in claim 46, in which at least two layers are crosslinked to one another at their common interface.

48. The device as claimed in claim 46 or 47, in which the monomer or polymer or mixture of at least one monomer and a polymer of at least one preceding layer is in each case insoluble or only slightly soluble in the following layer and/or in a solvent of a solution of a subsequent dip-coating.

49. The device as claimed in one of the preceding claims 37 to 48, in which at least one of the polymerized layers (12, 13, 121, 122, . . . 12N) comprises an electroluminescent material.

50. The device as claimed in one of the preceding claims 37 to 49, in which the transparent, conductive first layer (10) is an electronegative metal.

51. The device as claimed in claim 50, in which the electronegative metal comprises gold.

52. The device as claimed in one of claims 37 to 51, in which the transparent, conductive first layer (10) is a conductive metal oxide.

53. The device as claimed in claim 52, in which the conductive metal oxide comprises indium/tin oxide.

54. The device as claimed in one of the preceding claims 37 to 53, in which the electron-injecting contact (14) is calcium.
